(19) United States
(12) Patent Application Publication
(10) Pub. No.: US 2020/0000673 A1
(43) Pub. Date: Jan. 2, 2020

(54) A SUPPORT FRAME

(71) Applicant: EXYO DESIGN LTD, Sheffield (GB)

(72) Inventors: Andrew MORGAN, South Yorkshire (GB); Christopher HUGHES, South Yorkshire (GB)

(21) Appl. No.: 16/486,558

(22) PCT Filed: Feb. 15, 2018
(86) PCT No.: PCT/GB2018/050402

§ 371 Date: Aug. 16, 2019

(30) Foreign Application Priority Data
Feb. 16, 2017 (GB) 1702555.2

(51) Int. Cl. A61H 3/04

(52) U.S. Cl. CPC A61H 3/04; A61H 2201/0161; A61H 2201/0192; A61H 2201/1253

(57) ABSTRACT

A support frame (10) having an outer frame (12) and an inner frame (20) which are connected on both a first side (FS) and a second side (SS) by flexible fixed length tension members (61, 62,63,64,65,66), as well as an adjustable length tension member (50). The support frame has both a deployed and collapsible state, wherein the flexible fixed length tension members are under tension when deployed, and are slack when collapsed. This is achieved by reducing or increasing the length of the adjustable length tension member (50). The outer frame and inner frame rotate relative to one another around an axis of rotation xᵢ formed by a first hinge member (30) and a second hinge member (40).

### FIELD

The present invention relates to a support frame. More particularly the present invention relates to a collapsible posterior walking frame such as may be used in relation to a human requiring physical support, wherein the structure of support frame is maintained under tension by means of a series of tension members.

### Background

Walking frames are commonly used to provide physical support to persons who require aid when upright due to conditions affecting their ability to stand and move unsupported. Such devices are typically provided by means of a rigid frame which the user can grip with their hands to decrease the load on the leg muscles, and to provide a stable support for maintaining balance. Often these frames are constructed of lightweight, rigid materials, such as plastics or metals, which decreases weight to allow the user to handle them with greater ease.

Common frames typically involve a series of rigid interconnected poles which contact the floor at three or more points to provide a stable structure for the user. Many such walking frames are in front of the user in use, and as the user moves forward the frame is manually repositioned by the user to provide support.

Other walking frames are positioned behind the user, with the frame open on the front side, and the user pulls the frame with them as they move to provide continuous support whilst being free of obstruction by the frame. Typically, these devices either contact the ground with poles, wheels, or a mixture of the two such that stability and mobility are increased compared to the unaided user. Some examples of these frames are collapsible to allow easy stowage for transport or storage purposes. Some frames are height adjustable to allow the frame to better support users of differing physical size. Wheeled examples often include hand-operated brakes to reduce movement of the frame and increase stability when a user is standing still.

The largest group of people that have the ability to walk outdoors, but cannot, are young people who have cerebral palsy (CP), because the available support walkers are not suitable for off-road environments. The problems with current walking frames are the suspension, adjustability and weight. An improved off-road posterior walker could bring increased quality of life, autonomy and self-confidence to 3.7 million people. Inactivity among these patients; can lead from muscle contractures to debilitation, surgery and premature mortality; resulting in the highest cost to both the NHS and families, related to CP. The present invention addresses the major causes of inactivity because it is designed for access to active opportunities.

The support frame uses tensegrity principles to achieve improvements over prior art. A tensegrity system has a network of members under tension which are contiguous with one another, which interact with compression members which are not contiguous with one another, such that stability of the structure is provided by the system at equilibrium. The use of tensegrity in a support frame allows the tension members to provide suspension allowing the support frame to be used in uneven terrain, for example off-road.

A need exists for an improved support frame that can allow a user to traverse difficult terrain and is easily adjustable, lightweight and simple to use.

An object of this invention is to provide a support frame with improved suspension, weight, and adjustability, while promoting mobility and stability for the user in all environments.

### Summary of Invention

Accordingly, the present invention provides; a support frame which may have a front, a rear, a first side, a second side, a top and a bottom and may include two frames: an outer and an inner frame. The outer frame has; a first side portion on the first side and which may extend from a first bottom front position to a first top rear position, a second side portion on the second side which may extend from a second bottom front position to a second top rear position, and, a first connecting portion which may extend between and join the first top rear position and the second top rear position. The inner frame has; a third side portion on the first side which may extend from a first bottom rear position to a first top front position, a fourth side portion on the second side which may extend from a second bottom rear position to a second top front position, and a second connecting portion which may extend between and join the first bottom rear position and the second bottom rear position. Between the outer and inner frames there may be provided; a first hinge member between the first side of the outer frame and the third side portion of the inner frame, and a second hinge member between the second side of the outer frame and the fourth side portion of the inner frame. There may be a first adjustable length tension member which may connect to and extend between the first connecting portion and the second connecting portion. There may also be first and third flexible fixed length tension members on the first side, and said first fixed length tension member may extend between the third side portion and the first side portion and said third fixed length tension member may extend between the third side portion and the first connecting portion. There may also be fourth and sixth flexible fixed length tensions members on the second side. The fourth fixed length tension member may extend between the fourth side portion and the second side portion and said sixth fixed length tension member may extend between the fourth side portion and the first connecting portion.

The support frame may have a first, collapsed, state in which the first adjustable tension member and the flexible fixed length tension members may not be under tension, and, a second, deployed, position in which the first adjustable tension member and the flexible fixed length tension members may be under tension. The specific design of the support frame provides advantages to the user so that they will be able to traverse off-road terrain with ease. The use of tensegrity principles, as previously described, provides suspension, which allows the support frame to cope with uneven terrain more readily than the rigid support frames of the prior art. The frame also takes advantage of tensegrity principles to reduce weight, be more aesthetic, and increase durability by removing wearable and fatiguing parts. This inherent suspension of the support frame also provides dynamic support which can encourages a more natural gait pattern in the user. The frame is simple and easy to use, with a single interface to deploy and collapse the frame. These advantages will allow the user to experience walking in environments that were previously inaccessible.

The support frame may feature first and second hinge members which may further include; second and third adjustable length tension members, respectively, wherein said second adjustable length tension member may extend between the first top rear position of the outer frame and the first top front position of the inner frame and said third adjustable length tension member may extend between the second top rear position of the outer frame and the second top front position of the inner frame. These features advantageously provide a floating hinge which improves suspension, further increases stability of the frame by providing increased control over the degree of movement between the inner frame and outer frame, and reduces wear and fatigue on the support frame.

Furthermore, the second adjustable length tension member may extend from the first top rear position of the outer frame to and around the first top front position of the inner frame and return to the first top rear position of the outer frame and said third adjustable length tension member may extend from the second top rear position of the outer frame to and around the second top front position of the inner frame and return to the second top rear position of the outer frame. This feature further improves suspension and stability of the frame by providing increased control over the degree of movement between the inner frame and outer frame.

In some embodiments, the second and third adjustable length tension members may extend from the outer frame to and around the inner frame once on each side. Furthermore, the inner frame may have a plurality of guidance fixtures at the first and second top front positions through which the second and third adjustable length tension members may pass. Additionally, the first and second hinge members may include a second and third lockable length adjustment means, respectively, through which second and third adjustable length tension members may pass respectively. The inclusion of guidance fixtures and lockable length adjustment means further increases the stability of the hinge members, allowing greater control over the function of the hinge. The use of lockable length adjustment means also allows the hinge to be disassembled if required, which would be advantageous for storage of the frame. The support frame may have a gap between the outer frame and inner frame such that they may not be in physical contact. The advantage of this feature is that it reduces friction and wear which would otherwise occur between the inner frame and the outer frame.

The support frame may have an anchor point located on the second connecting portion to which the first adjustable length tension member may be attached, where said adjustable length tension member may include an engagement member to connect with the anchor point. This provides the advantage of allowing the frame to be quickly and easily be moved from the deployed to the collapsed state. Furthermore, the first connecting portion may have a first lockable length adjustment means through which first adjustable length tension member may pass. This feature allows the advantage that the length of the first adjustable length tension member can be quickly, reversibly, and securely altered. At either end of the first adjustable length tension member there may be a handle, and said handle may be operated to increase or decrease the length of the first adjustable length tension member passing through the lockable length adjustment means. This feature provides a user friendly interface for adjusting the length of the first adjustable length tension member. The outer frame may have a handle mount onto which the handle is releasably engaged.

The engagement member may have three pulleys, the first lockable length adjustment means may have three apertures, and the first adjustable length tension member passes through each of the pulleys and apertures. This feature allows easy adjustment of the adjustable length tension member by conferring a mechanical advantage to the user. In some embodiments the inner and outer frames may be generally U-shaped. One advantage of a generally U-shaped frame is increased frame strength over other shapes. Furthermore, the adjustable length tension members may be ropes, though further embodiments using other tension members such as belts, wires, strings, strips of material, or other reasonable composites are imagined. The use of ropes allows flexibility, collapsibility, and weight reduction above and beyond more rigid connection means. The adjustable locking means may be cleats. The use of cleats provides a simple and effective means for reversibly but securely adjusting the length of said adjustable length tension members.

The support frame may further include a rear wheel and two front wheels, wherein said rear wheel may be attached to the second connecting portion of the inner frame and said two front wheels may be attached to the outer frame at the first and second bottom front positions, respectively. Wheels provide a simple, adaptable means of moving the frame during use which, given the frame is designed for variable off-road terrain, are important considerations. Furthermore, said rear wheel may be a castored wheel. The use of a castored wheel is a simple, adaptable means of allowing the frame to easily change direction.

The support frame may further include adjustable user interaction portions, and said adjustable user interaction portions may be attached to the inner frame at the first and second top front positions in some embodiments. The use of adjustable user interaction portions provides a simple means for user manipulation of the frame and allows the frame to be easily adjusted for different users.

The first and fourth flexible fixed length tension members may be substantially parallel to one another, the second and fifth flexible fixed length tension members may be substantially parallel to one another, and the third and sixth flexible fixed length tension members may be substantially parallel to one another. Having these pairs of ropes parallel allows a simple means of balancing the tension of the frame such that the support frame maintains the deployed structure.

The outer frame and inner frame may have a plurality of anchor points. The first fixed length tension member may extend between a first and second anchor point, wherein the first anchor point may be located towards the bottom rear position of the inner frame and the second anchor point may be located towards the bottom front position of the outer frame. The second fixed length member may extend between a third and fourth anchor point, the third anchor point may be located towards the bottom front position of the outer frame and the fourth anchor point may be located towards the top front position of the inner frame. Furthermore, the third fixed length member may extend between a fifth and sixth anchor point, the fifth anchor point may be located towards the top front position of the inner frame and the sixth anchor point may be located on the first connecting portion of the outer frame. The fourth fixed length member may extend between a seventh and eighth anchor point, the seventh anchor point may be located towards the bottom rear position of the inner frame and the eighth anchor point may be located towards the bottom front position of the outer frame. The fifth fixed length member may extend between a ninth and tenth anchor point, the ninth anchor point may be located towards the bottom front position of the outer frame and the tenth anchor point may be located towards the top front position of the inner frame. Finally, the sixth fixed length member may extend between an eleventh and twelfth, the eleventh anchor point may be located towards the top front position of the inner frame and the twelfth anchor point may be located on the first connecting portion of the outer frame.

These fixed length members are imagined to be ropes, however, other tension members such as belts, wires, strings, strips of material, or other reasonable composites are envisioned in further embodiments. The anchor points may be integrally formed as part of the frame or welded onto the frame, however, in other embodiments they may be apertures within the frame, or the combination of an aperture within the frame and plug including one or more parts to which the flexible fixed length tension members are connected. These plugs may be reversibly, but securely, inserted into the apertures within the support frame allowing easy separation of the inner and outer frame, therefore easy assembly and disassembly of the support frame as a whole. This provides the advantage that the support frame can be easily disassembled for stowage.

The above may also including second flexible fixed length tension members on the first side which may extend between the first side portion and the third side portion. There may also be included fifth flexible fixed length tensions members on the second side which may extend between the second side portion and the fourth side portion.

As an alternative to the above, the first and second hinge members may include; first and second direct connectors and said first direct connector may extending between the first top rear position of the outer frame and the first top front position of the inner frame whilst said second direct connector may extend between the second top rear position of the outer frame and the second top front position of the inner frame. Each of said first and second direct connectors may each comprise flexible fixed length connectors.

The alternative arrangement may further include a second adjustable length tension member between the first top front position of the inner frame and the second top front region of the inner frame and may be tensionable to draw the first top front portion and the second top front region together and tension each of the first and second direct connectors.

### BRIEF DESCRIPTION OF DRAWINGS

The present invention will now be more particularly described by way of example only with reference to the accompanying drawings, in which:

FIG. 1 is a side-view from the first side showing an embodiment of the support frame;

FIG. 2 is a generally isometric view of an embodiment of the support frame as in FIG. 1;

FIG. 3 is a generally isometric view of an embodiment of the support frame;

FIG. 4 is a front view of the support frame as in FIG. 3;

FIG. 5 is a top-down view of the support frame as in FIG. 3;

FIG. 6 shows a side-view of the support frame in FIG. 3 in a collapsed state and an intermediary state between a deployed state and a collapsed state;

FIG. 7A shows a side-view of the support frame in FIG. 3 in a deployed state wherein the first adjustable length tension member is not connected to the inner frame;

FIG. 7B shows a close-up of the hinge of an embodiment of the support frame without the second adjustable length tension member;

FIGS. 8A and 8B show a cross-section of the hinge members of an embodiment of the support frame wherein the second adjustable length tension member is engaged and disengaged with the cleat respectively;

FIGS. 9A and 9B show a side-view and cross-sectional close-up respectively, from the first side of an embodiment of the support frame wherein the handle is engaged with the clip attached to the outer frame;

FIGS. 9C and 9D show a side-view and cross-sectional close-up respectively, from the first side of an embodiment of the support frame wherein the handle is disengaged with the clip attached to the outer frame;

FIG. 10A shows a rear view of an embodiment of the support frame where it is shown how the engagement member of the first lockable length adjustment means is connected to the first adjustable tension member;

FIG. 10B shows a close-up of the engagement member and anchor point attached to the inner frame of the support frame in FIG. 10A;

FIG. 11 is a side-view of a modified support frame;

FIG. 12 is an isometric representation of the support frame of FIG. 11;

FIG. 13 is a detailed isometric representation of the support frame of FIG. 11;

FIG. 14 is a rear view of the support frame of FIG. 11; and

FIG. 15 is a plan view of the support frame of FIG. 11.

### SPECIFIC DESCRIPTION

In the following embodiments, the term “front” and “rear” refer to the face of the device nearest and furthest, respectively, to the user. In other words, the front end of the frame is the end proximal to the back of user and the rear end is distal to the back of the user, during use. In addition, the terms “first side” and “second side” refer to the side of the invention on the right and left-hand side, respectively, of the user during use. Furthermore, the terms “top” and “bottom” refer to the face of the invention distal and proximal, respectively, to the ground during use.

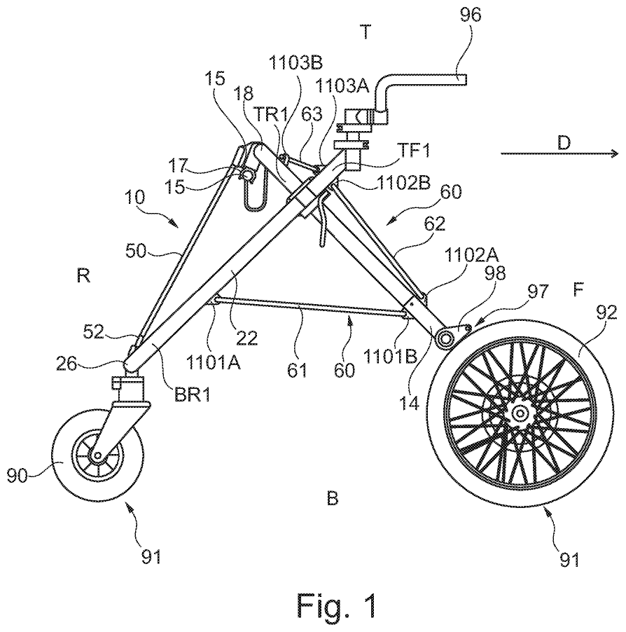

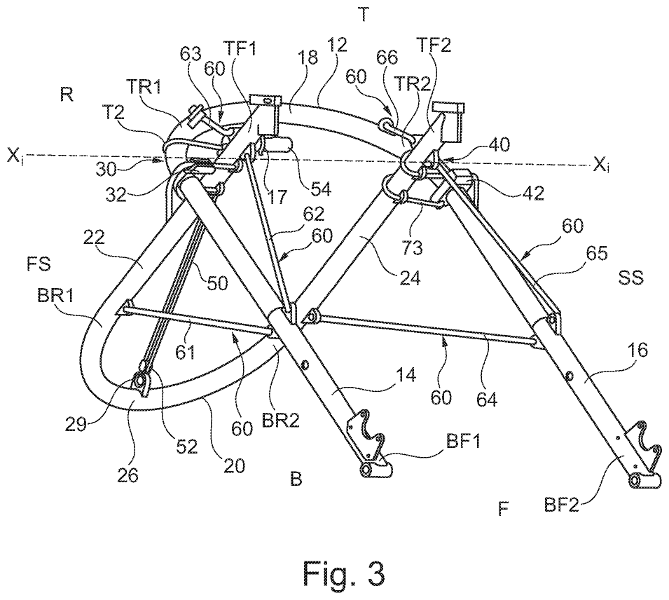

Referring now to the drawings in general but particularly to FIGS. 1 to 3, a support frame 10, commonly referred to as a posterior walking frame, is shown including an outer frame 12 and inner frame 20, connected with flexible tension members 60 described in detail later herein. The support frame 10 also includes user engagement portions 96 and ground engagement members 91 described in detail later herein, allowing a user standing at the front F of the support frame 10 to pull the device in a direction of movement D. The support frame 10 is open on the front F for unimpeded operation by the user.

The support frame 10 includes an outer frame 12 and an inner frame 20. The outer frame 12 includes a first side portion 14 which extends from a first bottom front position BF1 to a first top rear position TR1, and is connected by a first connecting portion 18 to the top rear position TR2 of a second side portion 16 which extends to a second bottom position BF2. The inner frame 20 includes a third side portion 22 which extends from a first bottom rear position BR1 to a first top front position TF1 connected by a second connecting portion 26 to the second bottom rear position BR2 of the fourth side portion 24, which extends towards a second top front position TF2.

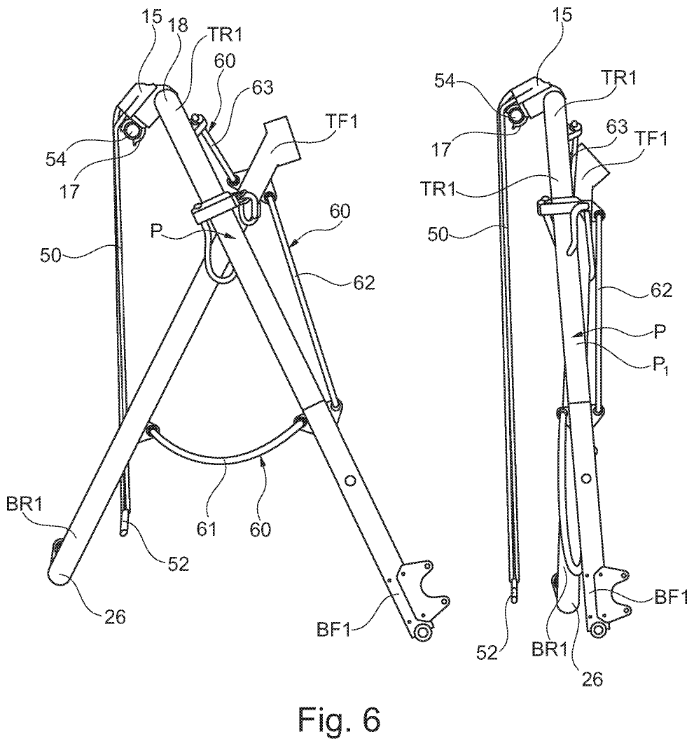

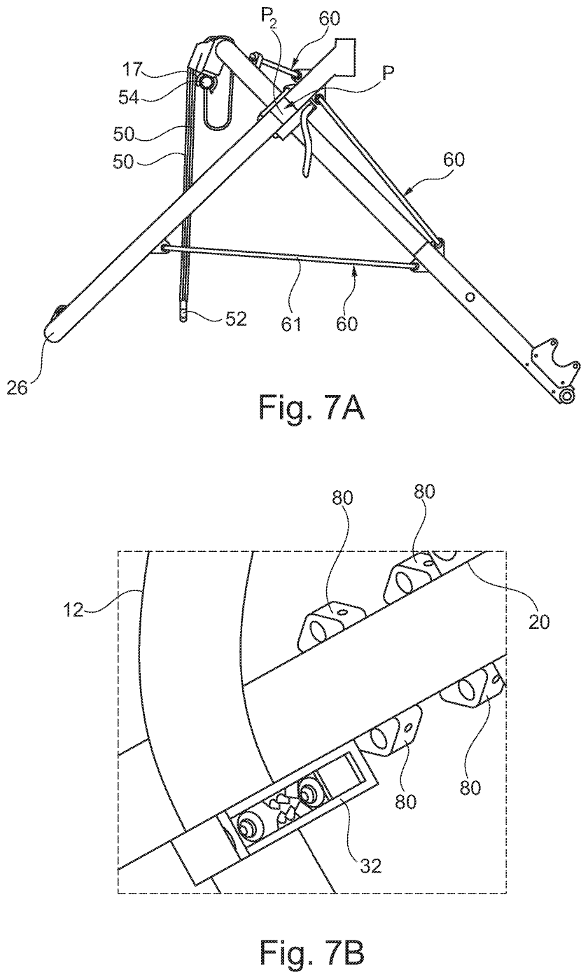

The outer frame 12 and inner frame 20 can pivot around the axis of rotation xᵢ of the two hinge members 30, 40, as shown in FIG. 6 and FIG. 7A. The first hinge member 30 connects the first side 14 of the outer frame 12 and the third side portion 22 of the inner frame 20. The second hinge member 30 connects the second side 16 of the outer frame 12 and the fourth side portion 24 of the inner frame 20. The outer frame 12 an inner frame 20 can rotate generally around an axis of rotation xᵢ defined by the first hinge member 30 and the second hinge member 40.

A first adjustable length tension member 50 connects the first connecting portion 18 of the outer frame 12 to the second connecting portion 26 of the inner frame 20. In the embodiment shown in FIGS. 1-3, this adjustable length tension member is a rope, though other tension members such as belts, wires, strings, strips of material, or other reasonable composites are imagined.

Additionally, the first side FS of the outer frame 12 is connected to the first side FS of the inner frame 20 by three flexible, fixed length tension members 61, 62, 63. The first fixed length tension member 61 connects the third side portion 22 of the inner frame 20 to the first side portion 14 of the outer frame 12. The second fixed length tension member 62 connects the first side portion 14 of the outer frame and the third side portion 22 of the inner frame. Furthermore, the third fixed length tension member 63 connects the third side portion 22 of the inner frame to the first connecting portion 18 of the outer frame 12. In the shown embodiment, these flexible fixed length tension members are ropes, though other tension members such as belts, wires, strings, strips of material, or other reasonable composites are imagined.

The second side SS of the outer frame 12 and inner frame 20 are also connected by three flexible fixed length tension members 64, 65, 66. The fourth fixed length tension member 64 connects the fourth side portion 24 of the inner frame 20 to the second side portion 16 of the outer frame 12. The fifth fixed length tension member 65 connects the fourth side portion 24 of the inner frame 20 to the second side portion 16 of the outer frame 12. Finally, the sixth fixed length tension member connects the fourth side portion 24 of the inner frame 20 to the first connecting portion 18 of the outer frame 12. As before, these flexible fixed length tension members are ropes in this embodiment though other tension members such as belts, wires, strings, strips of material, or other reasonable composites are imagined.

Increasing the length of the first adjustable length tension member 50 allows the inner frame 20 and outer frame 12 to rotate around the first hinge member 30 and second hinge member 40, allowing the support frame 10 to have a collapsed state for stowage. In this state, the flexible fixed length tension members 61, 62, 63, 64, 65, 66 are not under tension. Decreasing the length of the first adjustable length tension member 50 causes the inner frame 20 and outer frame 12 to rotate around the first hinge member 30 and second hinge member 40 such that the flexible fixed length tension members 61, 62, 63, 64, 65, 66 are under tension, and the frame is in a deployed state for use.

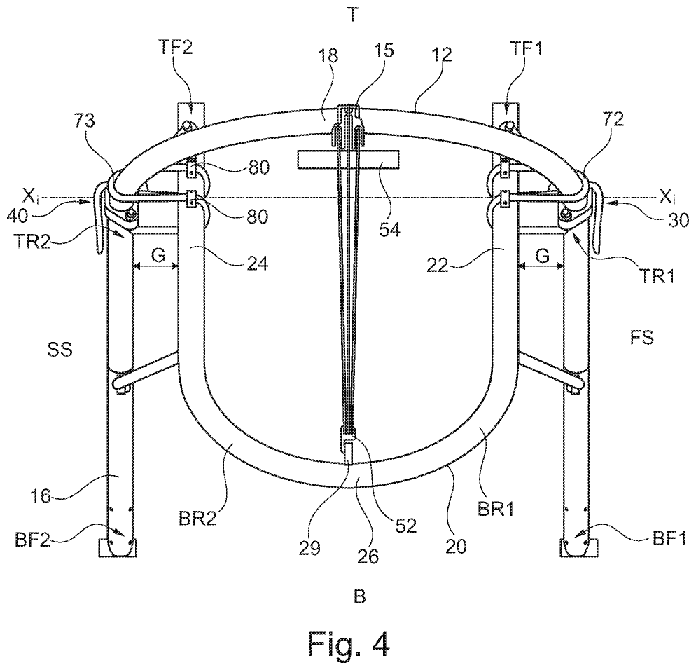

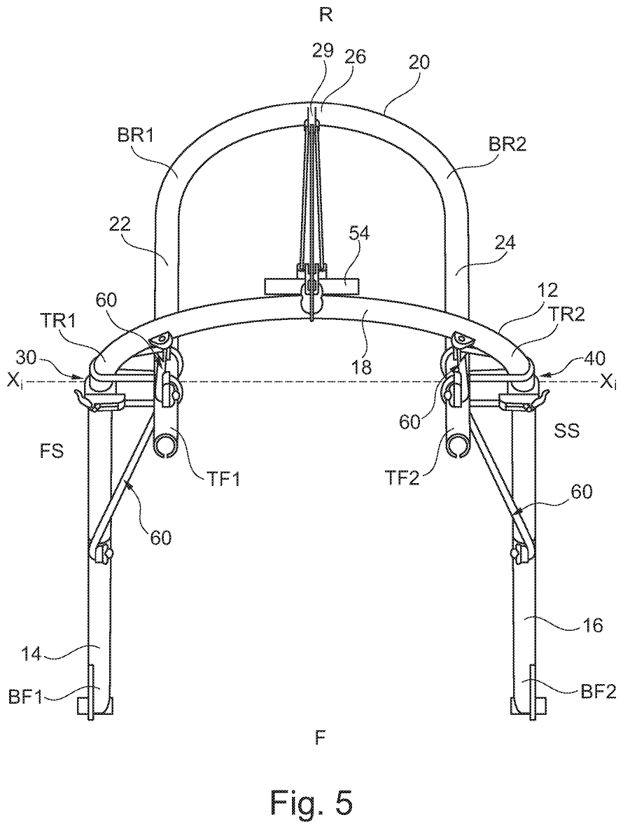

In some embodiments, the first and second hinge members 30, 40 are simply the point at which the inner frame 20 and outer frame 12 pivot relative to each other around an axis of rotation xᵢ. The first hinge member 30 can also be a physical connection formed by a second adjustable length tension member 72 which extends between the first top rear position TR1 of the outer frame 12 and the first top front position TF1 of the inner frame 14. Additionally, the second hinge member 40 can be a physical connection formed by a third adjustable length tension member 73 which extends between the second top rear position TR2 of the outer frame 12 and the second top front position TF2 of the inner frame 20. Furthermore, in an embodiment of the invention the second adjustable length tension member 72 extends from the first top rear position TR1 of the outer frame 12 to and around the first top front position TF1 of the inner frame 20 and returns to the first top rear position TR1 of the outer frame 12. Additionally, the third adjustable length tension member 73 extends from the second top rear position TR2 of the outer frame 12 to and around the second top front position TF2 of the inner frame 20 and returns to the second top rear position TR1 of the outer frame 12. An embodiment of these hinge members 30, 40 are shown in FIG. 4 and FIG. 5.

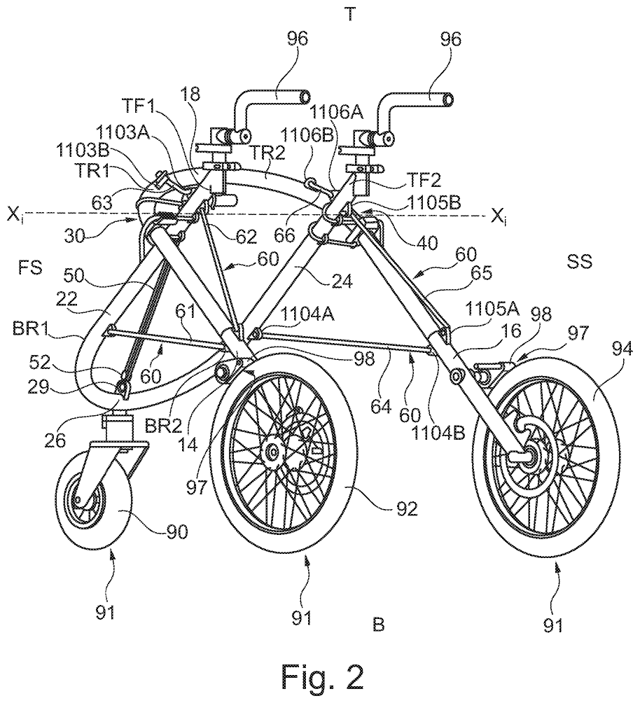

The second 72 and third 73 adjustable length tension members extend from the outer frame 12 to and around the inner frame 20 once on each side in an embodiment of the present invention. Furthermore, the inner frame 20 may have a plurality of guidance fixtures 80 at the first top front position TF1 and second top front position TF2 through which the second adjustable length tension member 72 and third adjustable length tension member 73 pass. A close up of this embodiment is shown in FIG. 7B, and the embodiment is shown more generally across FIGS. 2-5.

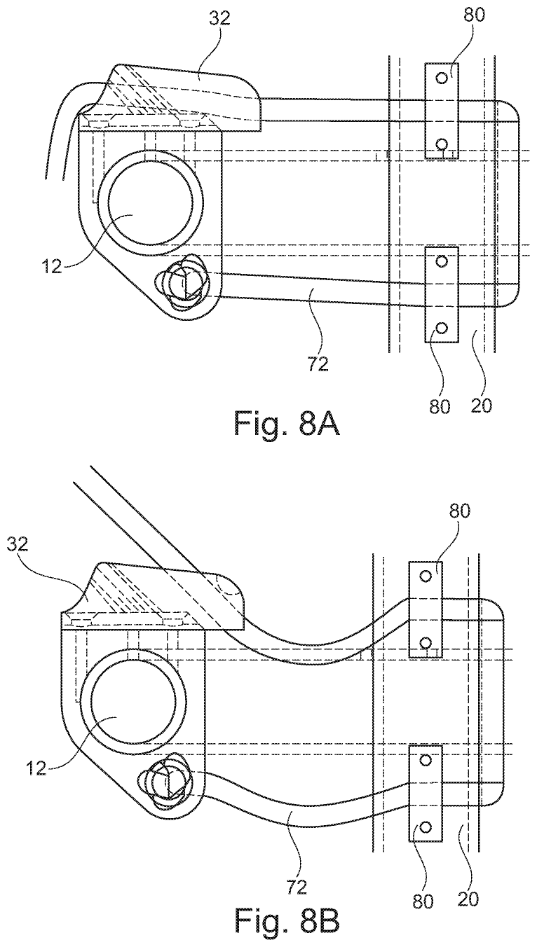

In some embodiments, the first hinge member 30 includes a second lockable length adjustment means 32 through which the second adjustable length tension member passes, as shown in FIGS. 7B, 8A, and 8B. Additionally, the second hinge member 40 includes a third lockable length adjustment means 42 through which the third adjustable length tension member 73 passes. These lockable length adjustment means allow the hinge members 30, 40 to be reversibly disassembled, such that the inner frame 20 and outer frame 12 are no longer substantially connected by the hinge members 30, 40. A specific embodiment of these hinge members as described is shown in cross sectional view in FIG. 8A and FIG. 8B. In a further embodiment, as shown in FIG. 4, there is a gap (G) between the outer frame 12 and inner frame 20 such that they are not in direct physical contact. This reduces wear and friction between the outer frame 12 and inner frame 20.

In some embodiments of the present invention the position of the hinge members 30, 40 and the position P of the axis of rotation xᵢ may change depending on the position of the outer frame 12 relative to the inner frame 20. For example, in FIGS. 6 and 7A, as the outer frame 12 and inner frame 20 rotate around the hinge members 30, 40 the axis of rotation xᵢ can be seen to move from a point P₁ approximately halfway down the outer frame to a point P₂ located towards the first connecting portion 16.

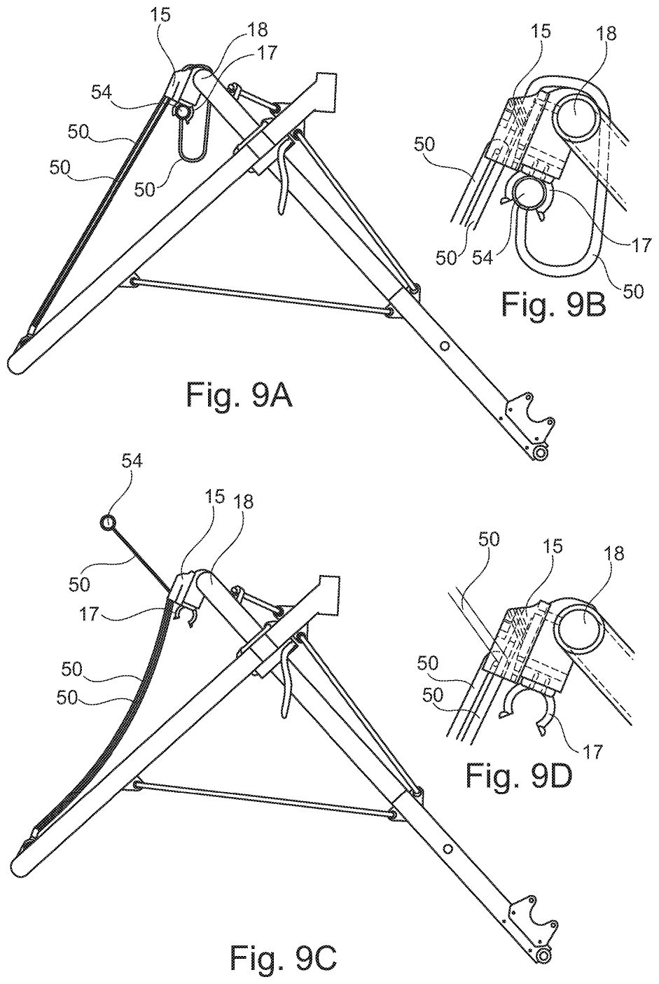

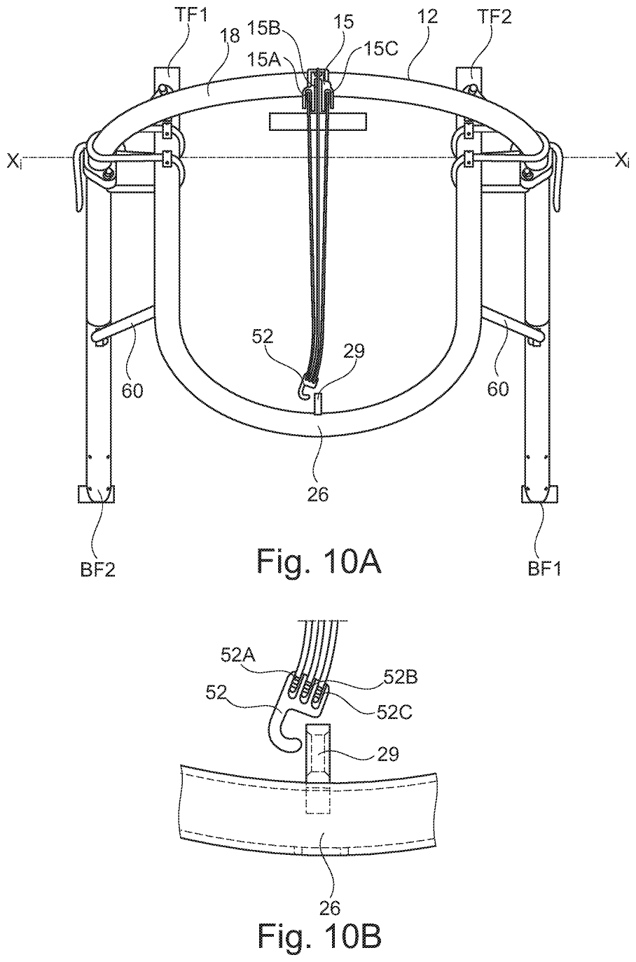

In an embodiment of the present invention, there is an anchor point 29 located on the second connecting portion 26 of the inner frame 20 to which the first adjustable length tension member 50 may be attached, as shown in FIG. 10B. Additionally, the first adjustable length tension member 50 has an engagement member 52 which connects to said anchor point 29, also shown in detail in FIG. 10B. In some embodiments the first connecting portion 18 of the outer frame 12 has a first lockable length adjustment means 15 through which the first adjustable length tension member 50 passes, as shown in FIGS. 9A, 9B, 9C, 9D and 10A. In some embodiments the first adjustable length tension member 50 has a handle 54 which can be operated to increase or decrease the length of the first adjustable length tension member 50 passing through the lockable length adjustment means 15. Further embodiments also include a handle mount 17 onto which the handle 54 can be releasably engaged.

The invention may include an engagement member 52 which has three pulleys 52A, 52B, 52C through which the first adjustable length tension member 50 passes. Furthermore, the first lockable length adjustment means may have three apertures 15A, 15B, 15C through which the first adjustable length tension member passes. This pulley and aperture system is shown in FIG. 10A and FIG. 10B. This pulley system allows a mechanical advantage to the user whereby the force applied when operating the first adjustable length tension member 50 is multiplied according to the number of pulleys and apertures. In the example embodiment described herein the mechanical advantage is 6, however, no mechanical advantage is also envisioned whereby the first adjustable length tension member 50 does not pass through a pulley system. Furthermore, further embodiments with differing numbers of pulleys are also imagined wherein the support frame 10 includes one or more pulleys.

The invention may include an outer frame 12 and an inner frame 20 which are U-shaped, however, other embodiments where each frame is substantially U-shaped, such as a V-shape, a flat-bottom U-shape, or other obvious shapes, are also imagined.

In an embodiment the adjustable length tension members 50, 72, 73 are ropes made of a suitable, flexible material. As discussed previously other types of tension members such as belts, strips of material or suitable composites are also envisioned. In the embodiment presented in FIG. 1 the adjustable locking means 15, 32, 42 are shown to be cleats, however, these adjustable locking means could be other reasonable means. For example, length could be reversibly adjusted using a clip, a latch, a buckle, or simply an anchor-point to which the adjustable length tension members can be tied to any desired length. Furthermore, the adjustable length tension members 50, 72, 73 could be tied to the frame itself, with a knot used to hold the adjustable length tension means at the desired length.

In the embodiment shown in FIGS. 1 and 2, the invention includes two front wheels 92, 94 attached to the outer frame 12 at the first and second bottom front positions BF1, BF2 and a rear wheel 90 attached to the second connecting portion 26 of the inner frame 20. Furthermore, the rear wheel 90 shown in FIGS. 1 and 2 is a castor wheel, but this represents one embodiment of the invention only. The skilled reader understands that these wheels could be reasonably replaced with other ground engagement members such as rollers. Furthermore, the skilled reader understands that the position of each wheel is by way of example only, and feasibly the position of these wheels could be altered. Furthermore, additional wheels could reasonably be added so that the frame includes 2 or more rear wheels, and/or 3 or more front wheels. An embodiment of the invention is also shown in FIG. 1 and FIG. 2 wherein each front wheel 92, 94 is in substantial contact with a brake 97. By way of example only FIGS. 1 and 2 show the brake 97 as a cam 98. In an embodiment of the invention the cams 98 operate in such a way that if the front wheels 92,94 turn towards the rear R, they apply increasing friction to the front wheels 92,94 to stop the support frame rolling in that direction. In contrast when moving in direction D towards the front F the cams operate such that friction between the cam and the front wheels 92, 94 is decreased to a minima, so as not to impede intentional movement of the support frame 10 in direction D. Alternative embodiments are also envisioned with a conventional braking system such as drum, disc, or caliper type brakes.

In FIGS. 1 and 2, the invention is shown with adjustable user interaction portions 96, by way of example only these are shown as handles. They are shown attached to the inner frame 20 at the first top front position TF1 and second top front position TF2 in this embodiment. In other embodiments the handles may be integrated with the frame, or other reasonable alternatives to that which is shown.

In the deployed state, when the flexible fixed length tension members 61, 62, 63, 64, 65, 66 are under tension as shown in FIGS. 1-3, pairs of flexible fixed length tension members are shown to be substantially parallel to one another. Specifically, the first 61 and fourth 64 flexible fixed length tension members are shown to be substantially parallel to one another. The second 62 and fifth 65 flexible fixed length tension members are shown to be substantially parallel to one another, and the third 63 and sixth 66 flexible fixed length tension members are also shown to be substantially parallel to one another. The skilled reader understands that this is only one arrangement of the present invention, and that the flexible fixed length tension members could be configured such that the invention operates in substantially the same way, but with some or none of the ropes being parallel.

FIGS. 1-3 show an embodiment of the invention wherein the support frame a plurality of anchor points 1101A, 1101B, 1102A, 1102B, 1103A, 1103B, 1104A, 1104B, 1105A, 1105B, 1106A, 1106B at various positions on the outer frame 12 and inner frame 20. This arrangement represents an example of the position of each of these anchor points, and the skilled reader understands that they may be positioned elsewhere on the outer frame 12 and inner frame 20. For example, 1101A and 1101B could be positioned facing the first side FS of the outer frame 12 and inner frame 20, or other reasonable positions in further embodiments. In the embodiment shown in FIGS. 1-3, the first fixed length tension member 61 extends between a first anchor point 1101A, positioned towards the bottom rear position BR1 of the inner frame 20, to a second anchor point 1101B, positioned towards the bottom front position BF1 of the outer frame 12. Additionally, the second fixed length tension member 62 extends between a third anchor point 1102A, located towards the bottom front position BF1 of the outer frame 12, and a fourth anchor point 1102B which is located towards the top front position TF1 of the inner frame 20. Additionally, the third fixed length tension member 63 extends between a fifth anchor point 1103A, located towards the top front position TF1 of the inner frame 20, and a sixth anchor point 1103B which is located on the first connecting portion 18 of the outer frame 12. Additionally, the fourth fixed length tension member 64 extends between a seventh anchor point 1104A, located towards the bottom rear position BR2 of the inner frame 20, and an eighth anchor point 1104B which is located towards the bottom front position BF2 of the outer frame 12. Additionally, the fifth fixed length tension member 65 extends between a ninth anchor point 1105A, located towards the bottom front position BF2 of the outer frame 12, and a tenth anchor point 1105B which is located towards the top front position TF2 of the inner frame 20. Furthermore, the sixth fixed length tension member 66 extends between an eleventh anchor point 1106A, located towards the top front position TF2 of the inner frame 20, and a twelfth anchor point 1106B which is located on the first connecting portion 18 of the outer frame 12. These arrangements and positions of flexible fixed length tension members and anchor points are only an example, and the skilled reader understands that further embodiments are possible wherein the position and interaction between these ropes and anchor points can be changed without fundamentally altering the invention. In the shown embodiment, the anchor points are raised points on the support frame with an aperture, however, other embodiments are envisioned wherein the anchor points are welded onto the support frame, an integral part of the support frame, an aperture within the support frame, or the combination of an aperture within the frame and a plug including one or more parts that can be reversibly, but securely, inserted into said aperture within the frame such that the flexible fixed length tension members are attached reversibly but securely to the plug. In some embodiments the flexible fixed length tension members can be reversibly but securely attached to the support frame to allow the inner and outer frame to be separated for stowage.

The use of the support frame 10 will now be described with reference to all of the figures but specifically FIGS. 1 and 2. In use, the support frame 10 is in the deployed state wherein the flexible fixed length tension members 60 are under tension, and the adjustable length tension member 50 is attached between the first connecting portion 18 and the second connecting portion 26. The user stands facing the front F, with their hands on the adjustable user interaction portions 96, and as they move in direction D the frame is pulled also in direction D. As the frame moves the tension of any of the flexible fixed length tension members 60 may change as force is unevenly applied to the ground engagement members 91 and the adjustable user interaction portions 96. The relative positions of the outer frame 12 and inner frame 20 are limited by the length of the fixed length tension members 60 such that the support frame 10 has a stable, but suspended structure. The length of the adjustable length tension member 50 can be varied such that the resting positions of the outer frame 12 and inner frame 20 are altered, and the rigidity of the deployed frame is also altered. At the end of use the support frame 10 can be collapsed by disconnecting the adjustable length tension member 50 from the first connecting portion 18 or the second connecting portion 26. This allows the outer frame 12 and inner frame 20 to rotate around the hinge members 30, 40, and rotate around an axis of rotation xᵢ until the length of the frames is substantially parallel and the frame is in a collapsed state as seen in FIG. 6. Furthermore, the hinge members 30, 40 may be disassembled to allow further movement of the outer frame 12 and inner frame 20 for stowage. Furthermore, the fixed length tension members 60 can be disconnected from the outer frame 12 and inner frame 20 to allow complete separation of the frames for storage.

It should be appreciated that although the figures show specific embodiments, that particular combinations of the various features described and defined in any embodiment of the invention can be implemented, examples such as the location of features on the frame and use of specific features, dimensions of the device and construction materials.

The support frame provides an easy to use device, with improved suspension, weight, and adjustability, while promoting mobility and stability for the user in all environments. This will allow the user to experience walking in environments that were previously inaccessible.

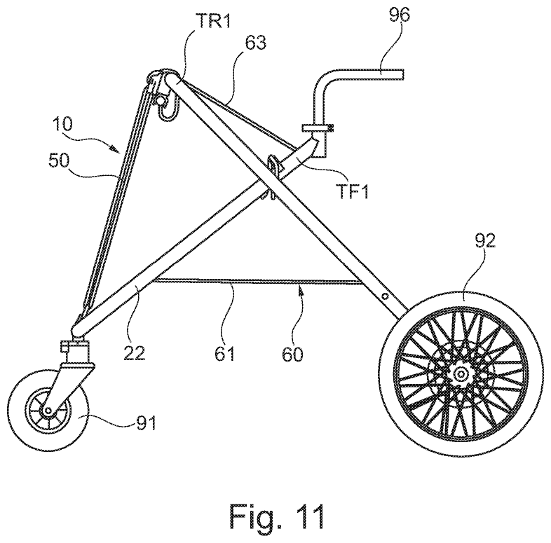

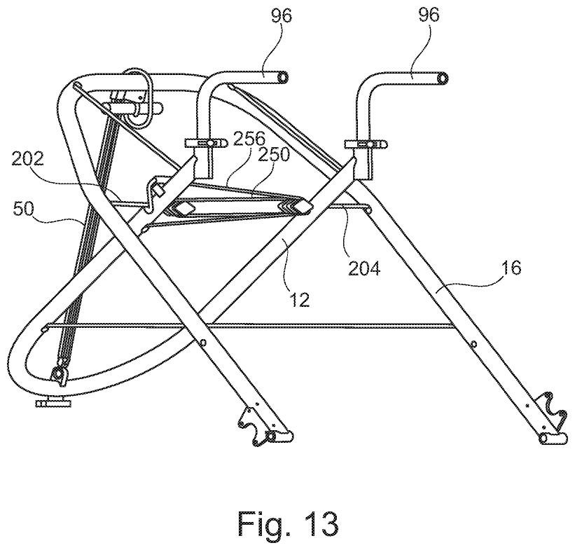

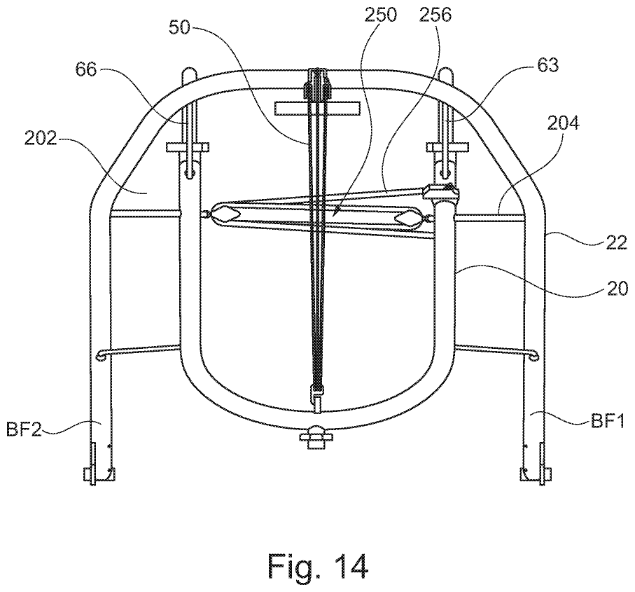

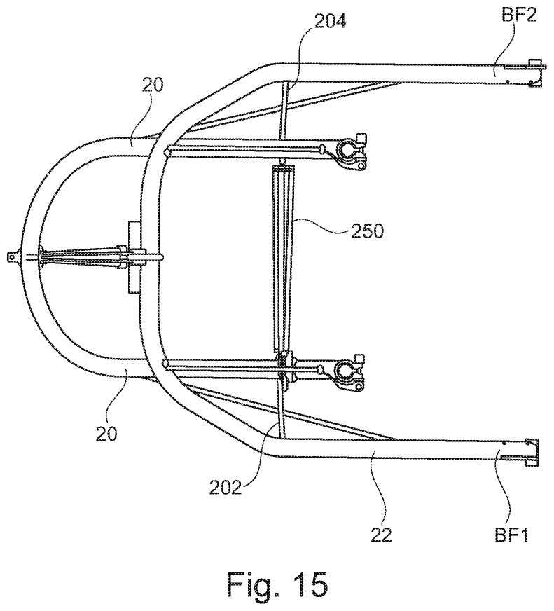

FIGS. 11 to 14 illustrate a slight variation on the basic design discussed above in which the second and fifth flexible fixed length tension members 62, 65 are eliminated. The additional drawings also illustrate an alternative way of hinging the outer and inner frames 12, 20 to each other and still further illustrate an alternative way of tensioning the hinges 30 and 40. Other than these amended items the remaining components of the support frame 10 remain substantially or entirely the same so are not described in detail in this section but for convenience the same reference numbers have been used below when referring to items the same as described above.

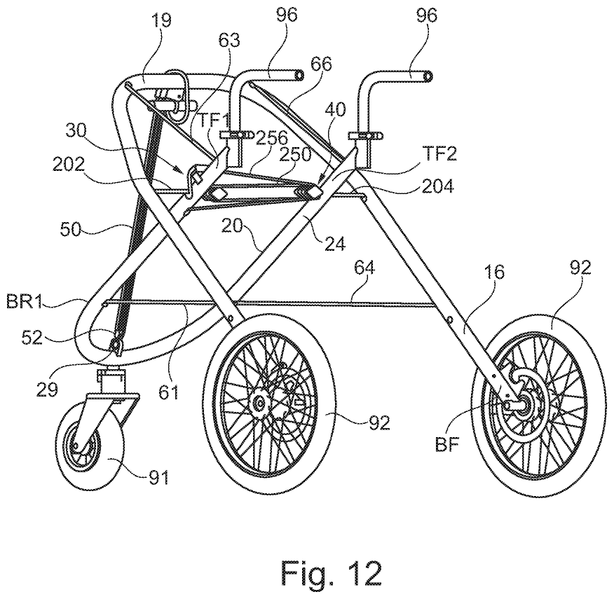

Referring now particularly to FIGS. 11 and 12, the support frame 10 still comprises an outer frame 12 and an inner frame 20 but the second and fifth tension members 62 and 65 have been omitted. In this alternative arrangement the first and second hinge members 30, 40 include first and second direct connectors 202, 204, said first direct connector 202 extending between the first top rear position TR1 of the outer frame 12 and the first top front position TF1 of the inner frame 14 and said second direct connector 204 extending between the second top rear position TR2 of the outer frame 12 and the second top front position TF2 of the inner frame 20. Whilst it will be appreciated that the first and second direct connectors 202, 204 could be solid/rigid connectors, it has been found that they are preferably provided as flexible fixed length connectors as such an arrangement lends itself to easy folding. A second adjustable length tension member 250 is provided between the first top front position TF1 of the inner frame 20 and the second top front region TF2 of the inner frame 20. The second tension member 250 may comprise a pair of pulleys 252, 254 provided on inner sides of the inner frame 20 working in combination with a length of tensionable rope 256 extending between said pulleys 252, 254 and being securable in a cleat 258 or other such similar device once the required tension has been achieved. The required tension is that which causes the two sides of the inner frame 20 to be drawn together to draw the first top front portion TF1 and the second top front region TF2 together and tension each of the first and second direct connectors 102, 104.

1. A support frame (10) having a front (F), a rear (R), a first side (FS), a second side (SS), a top (T) and a bottom (B) and including:
a. an outer frame (12) having a first side portion (14) on the first side (FS) and extending from a first bottom front position (BF1) to a first top rear position (TR1), a second side portion (16) on the second side (SS) extending from a second bottom front position (BF2) to a second top rear position (TR2) and a first connecting portion (18) extending between and joining the first top rear position (TR1) and the second top rear position (TR2);
b. an inner frame (20) having a third side portion (22) on the first side (FS) and extending from a first bottom rear position (BR1) to a first top front position (TF1), a fourth side portion (24) on the second side (SS) and extending from a second bottom rear position (BR2) to a second top front position (TF2) and a second connecting portion (26) extending between and joining the first bottom rear position (BR1) and the second bottom rear position (BR2);
c. a first hinge member (30) between the first side (14) of the outer frame (12) and the third side portion (22) of the inner frame (20);
d. a second hinge member (40) between the second side (16) of the outer frame (12) and the fourth side portion (24) of the inner frame (20);
e. a first adjustable length tension member (50) connected to and extending between the first connecting portion (18) and the second connecting portion (26);
f. first and third flexible fixed length tension members (61, 63) on the first side (FS), said first fixed length tension member (61) extending between the third side portion (22) and the first side portion (14)and the third side portion (22), said third fixed length tension member (63) extending between the third side portion (22) and the first connecting portion (18);
g. fourth and sixth flexible fixed length tensions members (64, 66) on the second side (SS), said fourth fixed length tension member (64) extending between the fourth side portion (24) and the second side portion (16) and the fourth side portion (24), said sixth fixed length tension member (66) extending between the fourth side portion (24) and the first connecting portion (18); and
h. wherein the support frame (10) has a first, collapsed, state in which the first adjustable tension member (50) and the flexible fixed length tension members (61, 62, 63, 64, 65, 66) are not under tension and a second, deployed, position in which the first adjustable tension member (50) and the flexible fixed length tension members (61, 62, 63, 64, 65, 66) are under tension.

2. A support frame (10) as claimed in claim 1, wherein the first and second hinge members (30, 40) include; second and third adjustable length tension members (72, 73) respectively, said second adjustable length tension member (72) extending between the first top rear position (TR1) of the outer frame (12) and the first top front position (TF1) of the inner frame (14) and said third adjustable length tension member (73) extending between the second top rear position (TR2) of the outer frame (12) and the second top front position (TF2) of the inner frame (20).

3. A support frame (10) as claimed in claim 2, wherein the second adjustable length tension member (72) extends from the first top rear position (TR1) of the outer frame (12) to and around the first top front position (TF1) of the inner frame (20) and returns to the first top rear position (TR1) of the outer frame (12) and said third adjustable length tension member (73) extends from the second top rear position (TR2) of the outer frame (12) to and around the second top front position (TF2) of the inner frame (20) and returns to the second top rear position (TR1) of the outer frame (12) and wherein the second and third adjustable length tension members (72, 73) extend from the outer frame (12) to and around the inner frame (20) once on each side.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A support frame (10) as claimed in claim 1, wherein the support frame (10) further includes a rear wheel (90) and two front wheels (92, 94), said rear wheel (90) is attached to second connecting portion (26) of the inner frame (20), said two front wheels (92, 94) are attached to the outer frame (12) at the first and second bottom front positions (BF1, BF2) respectively.

18. (canceled)

19. A support frame (10) as claimed in claim 1, wherein the support frame (10) further includes adjustable user interaction portions (96), said adjustable user interaction portions (96) are attached to the inner frame (20) at the first and second top front positions (TF1, TF2).

20. (canceled)

21. (canceled)

22. A support frame (10) as claimed in claim 1, wherein the first fixed length tension member (61) extends between a first and second anchor point (1101A, 1101B), the first anchor point (1101A) located towards the bottom rear position (BR1) of the inner frame (20) and the second anchor point (1101B) located towards the bottom front position (BF1) of the outer frame (12).

23. A support frame (10) as claimed in claim 1, wherein the second fixed length member (62) extends between a third and fourth anchor point (1102A, 1102B), the third anchor point (1102A) is located towards the bottom front position (BF1) of the outer frame (12) and the fourth anchor point (1102B) is located towards the top front position (TF1) of the inner frame (20).

24. A support frame (10) as claimed in claim 1, wherein the third fixed length member (63) extends between a fifth and sixth anchor point (1103A, 1103B), the fifth anchor point (1103A) is located towards the top front position (TF1) of the inner frame (20) and the sixth anchor point (1103B) is located on the first connecting portion (18) of the outer frame (12).

25. A support frame (10) as claimed in claim 1, wherein the fourth fixed length member (64) extends between a seventh and eighth anchor point (1104A, 1104B), the seventh anchor point (1104A) located towards the bottom rear position (BR2) of the inner frame (20) and the eighth anchor point (1104B) located towards the bottom front position (BF2) of the outer frame (12).

26. A support frame (10) as claimed in claim 1, wherein the fifth fixed length member (65) extends between a ninth and tenth anchor point (1105A, 1105B), the ninth anchor point (1105A) is located towards the bottom front position (BF2) of the outer frame (12) and the tenth anchor point (1105B) is located towards the top front position (TF2) of the inner frame (20).

27. A support frame (10) as claimed in claim 1, wherein the sixth fixed length member (66) extends between an eleventh and twelfth (1106A, 1106B), the eleventh anchor point (1106A) is located towards the top front position (TF2) of the inner frame (20) and the twelfth anchor point (1106B) is located on the first connecting portion (18) of the outer frame (12).

28. (canceled)

29. A support frame (10) as claimed in claim 1 and including second flexible fixed length tension members (62) on the first side (FS), said second fixed length tension member (62) extending between the first side portion (14) and the third side portion (22)); and a fifth flexible fixed length tensions members (65) on the second side (SS), said fifth fixed length tension member (65) extending between the second side portion (16) and the fourth side portion (24).

30. A support frame (10) as claimed in claim 1, wherein the first and second hinge members (30, 40) include; first and second direct connectors (202, 204), said first direct connector (202) extending between the first top rear position (TR1) of the outer frame (12) and the first top front position (TF1) of the inner frame (14) and said second direct connector (204) extending between the second top rear position (TR2) of the outer frame (12) and the second top front position (TF2) of the inner frame (20).

31. A support frame (10) as claimed in claim 30, wherein each of said first and second direct connectors (202, 204) each comprise flexible fixed length connectors.

32. A support frame as claimed in claim 30 and including a second adjustable length tension member (250) between the first top front position (TF1) of the inner frame (20) and the second top front region (TF2) of the inner frame (20) and being tensionable to draw the first top front portion (TF1) and the second top front region (TF2) together and tension each of the first and second direct connectors (202, 204).
